(19) United States
(12) Patent Application Publication
(10) Pub. No.: US 2017/0217357 A1
(43) Pub. Date: Aug. 3, 2017

(54) Bottled Water Transporting Device

(71) Applicants: Pamela Mckenzie, Austin, TX (US); LeRoy Charles Dunning, Austin, TX (US)

(72) Inventors: Pamela Mckenzie, Austin, TX (US); LeRoy Charles Dunning, Austin, TX (US)

(21) Appl. No.: 15/014,165

(22) Filed: Feb. 3, 2016

(51) Int. Cl. B60P 7/06; F16M 11/24

(52) U.S. Cl. CPC B60P 7/06; F16M 11/24

(57) ABSTRACT

This invention is a device to safely transport drinking water containers or other liquids in containers. The invention is designed in two parts that can interlock at the center to form a stable ‘X’ shape. The invention can be disassembled for easy storage and re assembled to carry large bottles of water or other fluids in similar containers in various modes of transportation without spilling. The invention can be constructed as a one-part design without changing the spirit of the invention.

### BACKGROUND OF THE INVENTION

The present design relates to transportation of water or fluids in containers in carriers or supports. More specifically, the present invention relates to a means of transporting drinking water in 1, 2.5, 3 and 5 gallon jugs but can be created in various sizes and diameter to accommodate any size container of water or fluid. Transporting large filled bottles of water can be dangerous requiring them to be tied down, or secured in any number of ways to prevent the weight of the container from becoming a moving hazard during transport inside the vehicle of transport. This utilitarian invention solves these many problems by holding the container in a holder/carrier that can be used to transport the container safely reducing the risk of hazard.

### SUMMARY OF THE INVENTION

The present invention relates to a means of transporting and storing water in a holder that can be assembled and disassembled for ease of use. It is constructed of two nearly identical parts that, when assembled, provide 4 upright posts to contain and support any size container of fluids to prevent spillage or overturning during transport. This creates a new design such that fluid filled containers can be held in this safe way for transport. The design can be created in any number of appropriately sturdy materials, wood, plastic, metal or any material without changing the spirit of the utility and design of the device. Once assembled the device can protect the liquid in the container from moving unpredictably and dangerously while being transported in a back seat or front seat of a car or any vehicle or payload area of a truck but is not restricted to these modes of transportation. It can be also used at the destination to hold the container of fluid for later use. A unique design feature is that it can be disassembled for easy storage in a vehicle to minimize the space needed to store it when it is not in use. It can also be constructed as a one-part x shaped design that performs the same function. It can also be made in such a way as a single x shaped unit with an annular holder that does not change the spirit of the design function: carrying water containers to and from water dispensers safely.

### BRIEF DESCRIPTION OF THE DRAWINGS

The accompanying drawings illustrate the invention. In such Drawings:

FIG. 1 is a view of the assembled parts showing the two parts of the invention and how they fit together as a utilitarian device.

FIG. 1a is a view of parts showing a detail of the individual parts as described in FIG. 1 that allows the means of affixing and combining them into the utilitarian function.

FIG. 2 is a view of the device in use showing the utilitarian function.

### DETAILED DESCRIPTION OF THE PREFERRED EMBODIMENTS

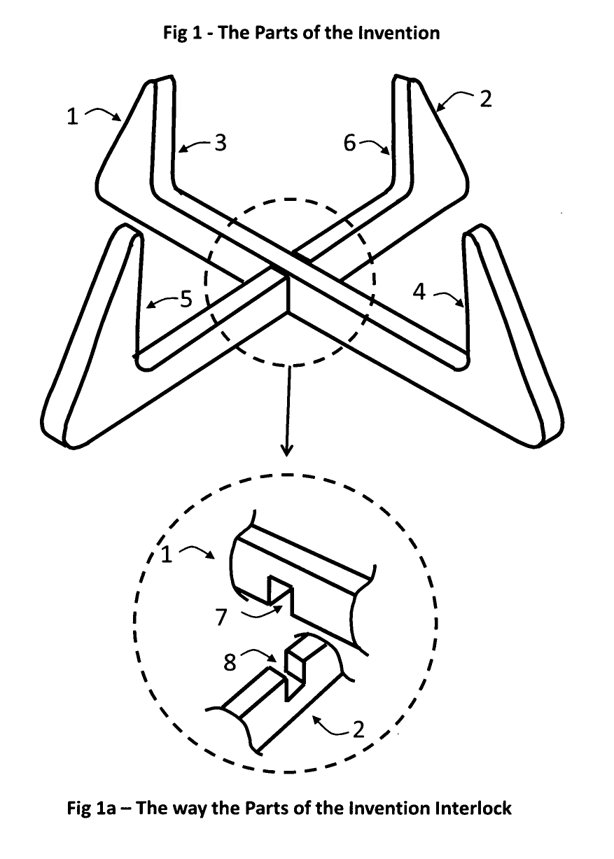

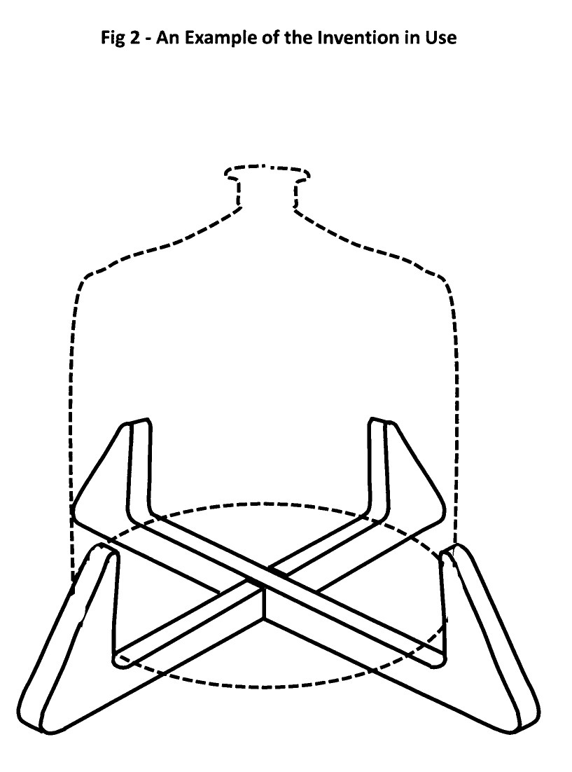

A preferred embodiment is described referring to the attached drawings FIG. 1 and FIG. 2. The two parts shown in FIGS. 1, (1) and (2) are flat pieces made of any number of sturdy materials that can perform the utility of the device. There are two up right projections (3) and (4) on part (1) and two upright projections (5) and (6) on part (2) that serve the purpose of laterally supporting a container of material, liquid in this case, during transport to hold it firmly in the upright position. This design could also be made with several pieces that when assembled have also upright projections and the invention is not restricted to only exhibiting two or four up right projections. As seen in FIG. 1a the center span on part (1) is notched (7) at the center to accommodate the notch (8) in the center span of part (2) such that the notch (7) and notch (8) on the two pieces interlock to fit snugly to create the three dimensional configuration (as seen in FIG. 1) for the actual transporting and storage of a container. This is also shown in FIG. 2 where the two parts are assembled by the center span connection to configure the device for the utility function with a representation of a container held in the invention. This commonality of parts and easy assembly and disassembly is a unique feature of the current invention. Although it may take any number of designs and ornamental shapes to create part (1) and part (2) the design of the device does not change the spirit of the invention for the utilitarian purpose (FIG. 2) of transporting bottles of fluids upright.

1-3. (canceled)

4. Can carry water battles in a moving vehicle.

5. Has cut outs in each of the four upright supports for fixing carrier securely in a moving vehicle employing seat belts of the vehicle.
